(19) United States
(12) Patent Application Publication
(10) Pub. No.: US 2007/0200503 A1
(43) Pub. Date: Aug. 30, 2007

(54) Methods and apparatus for extending the lifespan of fluorescent lamps

(75) Inventors: Scot Olson, Scottsdale, AZ (US); Bruce Pitman, Phoenix, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/364,141

(22) Filed: Feb. 27, 2006

(51) Int. Cl. H01J 61/12; H01J 17/20

(52) U.S. Cl. 313/637

(57) ABSTRACT

Methods and apparatus are provided for increasing the life of a fluorescent lamp suitable for use as a backlight in an avionics or other liquid crystal display (LCD). The apparatus includes a channel configured confine a vaporous material that produces an ultra-violet light when electrically excited. A layer of light-emitting material disposed within at least a portion of the channel is responsive to the ultra-violet light to produce the visible light emitted from the lamp. To increase the lifespan of the lamp, a protective coating is provided on the layer of light-emitting material. The protective coating comprises a material that is transparent to both ultra-violet and visible light, yet is capable of filling even small gaps in the light-emitting material. In lamps wherein the vaporous material comprises mercury and the light-emitting material comprises a phosphorescent material, for example, the protective material may comprise fused silica (i.e. silica dioxide or “quartz glass”).

### TECHNICAL FIELD

The present invention generally relates to fluorescent lamps, and more particularly relates to techniques and structures for improving the lifespan of fluorescent lamps such as those used in liquid crystal displays.

### BACKGROUND

A fluorescent lamp is any light source in which a fluorescent material transforms ultraviolet or other lower wavelength energy into visible light. Typically, fluorescent lamps include a glass or plastic tube that is filled with argon or other inert gas, along with mercury vapor or the like. When an electrical current is provided to the contents of the tube, the resulting arc causes the mercury gas within the tube to emit ultraviolet radiation, which in turn excites phosphors coating the inside lamp wall to produce visible light. Fluorescent lamps have provided lighting in numerous home, business and industrial settings for many years.

More recently, fluorescent lamps have been used as backlights in liquid crystal displays such as those used in computer displays, cockpit avionics, and the like. Such displays typically include any number of pixels arrayed in front of a relatively flat fluorescent light source. By controlling the light passing from the backlight through each pixel, color or monochrome images can be produced in a manner that is relatively efficient in terms of physical space and electrical power consumption. Despite the widespread adoption of displays and other products that incorporate fluorescent light sources, however, designers continually aspire to improve the amount of light produced by the light source, to extend the life of the light source, and/or to otherwise enhance the performance of the light source, as well as the overall performance of the display.

Accordingly, it is desirable to provide a fluorescent lamp and associated methods of building and/or operating the lamp that improve the performance and lifespan of the lamp. Other desirable features and characteristics will become apparent from the subsequent detailed description of the invention and the appended claims, taken in conjunction with the accompanying drawings and this background of the invention.

### BRIEF SUMMARY

In various embodiments, methods and apparatus are provided for increasing the lifespan of a fluorescent lamp suitable for use as a backlight in an avionics, computer or other liquid crystal display (LCD). The apparatus suitably includes a light-emitting channel configured to confine a vaporous material that produces an ultra-violet light when electrically excited. A layer of light-emitting material disposed within at least a portion of the channel is responsive to the ultra-violet light to produce the visible light emitted from the lamp. To increase the lifespan of the lamp, a protective coating is provided on the layer of light-emitting material. The protective coating comprises a material that is substantially transmissive to light in the ultraviolet and in the visible spectra, yet is suitable for filling cracks in the light-emitting material. In lamps wherein the vaporous material comprises mercury and the light-emitting material comprises a phosphorescent material, for example, the protective material may comprise fused silica (i.e. silica dioxide or “quartz glass”).

In another embodiment, a method of making a fluorescent lamp suitable for use in a liquid crystal display includes the broad steps of forming a phosphor or other light-emitting layer within the channel, and then sputtering or otherwise forming a layer of protective material of fused silica or the like to substantially cover the light-emitting layer. This protective material effectively prevents the vaporous material from diffusing into the phosphor, which is known to adversely affect the lifespan of the lamp.

Other embodiments include other lamps or displays incorporating structures and/or techniques described herein. Additional detail about various exemplary embodiments is set forth below.

### BRIEF DESCRIPTION OF THE DRAWINGS

The present invention will hereinafter be described in conjunction with the following drawing figures, wherein like numerals denote like elements, and

FIG. 1 is an exploded perspective view of an exemplary flat panel display;

FIG. 2 is a cross-sectional side view of an exemplary fluorescent lamp with a protective coating provided over the light-emitting layer;

FIG. 3 is a side view of an exemplary aperture lamp provided with a protective coating.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

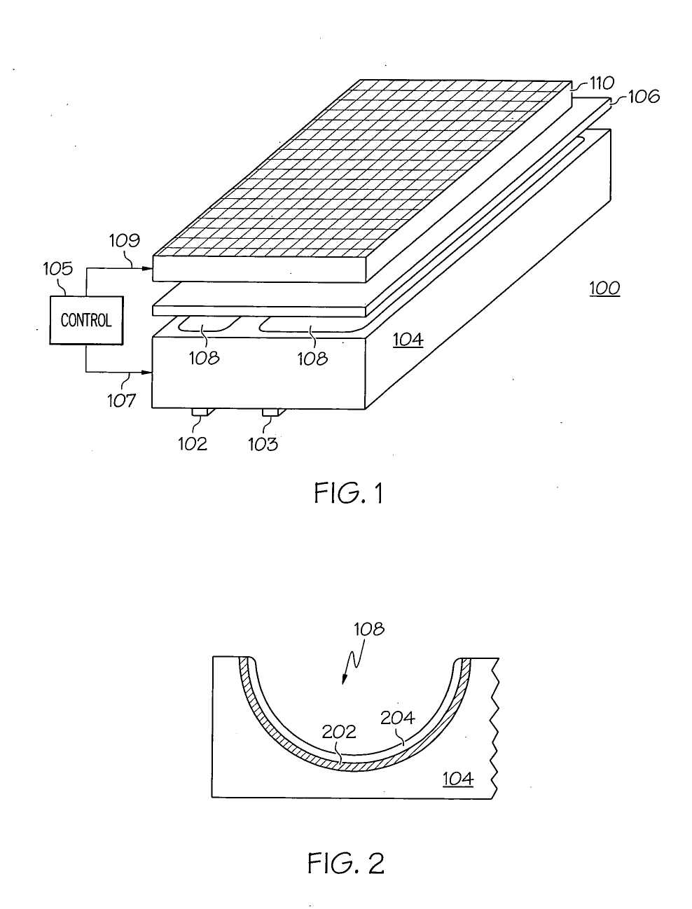

Turning now to the drawing figures and with initial reference to FIG. 1, an exemplary flat panel display 100 suitably includes a backlight assembly with a substrate 104 and a faceplate 106 confining appropriate materials for producing visible light within one or more channels 108. Typically, materials present within channel(s) 108 include argon (or another relatively inert gas), mercury and/or the like. To operate the lamp, an electrical potential is created across the channel 108 (e.g. by coupling electrodes 102, 103 to suitable voltage sources and/or driver circuitry), the gaseous mercury is excited to a higher energy state, resulting in the release of a photon that typically has a wavelength in the ultraviolet light range. This ultraviolet light, in turn, provides “pump” energy to phosphor compounds and/or other light-emitting materials located in the channel to produce light in the visible spectrum that propagates outwardly through faceplate 106 toward pixel array 110.

The light that is produced by backlight assembly 104/106 is appropriately blocked or passed through each of the various pixels of array 110 to produce desired imagery on the display 100. Conventionally, display 100 includes two polarizing plates or films, each located on opposite sides of pixel array 110, with axes of polarization that are twisted at an angle of approximately ninety degrees from each other. As light passes from the backlight through the first polarization layer, it takes on a polarization that would ordinarily be blocked by the opposing film. Each liquid crystal, however, is capable of adjusting the polarization of the light passing through the pixel in response to an applied electrical potential. By controlling the electrical voltages applied to each pixel, then, the polarization of the light passing through the pixel can be “twisted” to align with the second polarization layer, thereby allowing for control over the amounts and locations of light passing from backlight assembly 104/106 through pixel array 110. Most displays 100 incorporate control electronics 105 to activate, deactivate and/or adjust the electrical parameters 109 applied to each pixel. Control electronics 105 may also provide control signals 107 to activate, deactivate or otherwise control the backlight of the display. The backlight may be controlled, for example, by a switched connection between electrodes 102, 103 and appropriate power sources. While the particular operating scheme and layout shown in FIG. 1 may be modified significantly in some embodiments, the basic principals of fluorescent backlighting are applied in many types of flat panel displays 100, including those suitable for use in avionics, desktop or portable computing, audio/video entertainment and/or many other applications.

Fluorescent lamp assembly 104/106 may be formed from any suitable materials and may be assembled in any manner. Substrate 104, for example, is any material capable of at least partially confining the light-producing materials present within channel 108. In various embodiments, substrate 104 is formed from ceramic, glass and/or the like. The general shape of substrate 104 may be fashioned using conventional techniques, including sawing, routing, molding and/or the like. Further, and as described more fully below, channel 108 may be formed and/or refined within substrate 104 by sandblasting in some embodiments.

Channel 108 is any cavity, indentation or other space formed within or around substrate 104 that allows for partial or entire confinement of light-producing materials. In various embodiments, lamp assembly 104/108 may be fashioned with any number of channels, each of which may be laid out in any manner. Serpentine patterns, for example, have been widely adopted to maximize the surface area of substrate 104 used to produce useful light. U.S. Pat. No. 6,876,139, for example, provides several examples of relatively complicated serpentine patterns for channel 108, although other patterns that are more or less elaborate could be adopted in many alternate embodiments.

With reference now to FIG. 2, channel 108 in substrate 104 is suitably provided with a light-emitting material 202 and a protective layer 204. Channel 108 is appropriately formed in substrate 104 by milling, molding or the like, and light-emitting material 202 is applied though spraying or any other conventional technique. Light-emitting material 202 is typically a phosphorescent compound capable of producing visible light in response to “pump” energy (e.g. ultraviolet light) emitted by vaporous materials confined within channel 108. Various phosphors used in fluorescent lamps include any presently known or subsequently developed light-emitting materials, which may be individually or collectively employed in a wide array of alternate embodiments. Light emitting layer 202 may be applied or otherwise formed in channel 108 using any technique, such as conventional spraying or the like.

Protective layer 204 may be provided on light-emitting layer 202 to prevent argon, mercury or other vapor molecules from diffusing into the phosphor or other light-emitting material. While certain coatings (such as aluminum oxide) have been applied in various conventional lamp designs, such coatings may not be able to prevent adverse effects upon the lifespan of the lamp in certain applications and environments. In particular, the relative size of aluminum oxide molecules can prevent full covering of cracks or gaps that may occur in some embodiments of light-emitting layer 102. These cracks or gaps could, under certain circumstances, allow some vapor particles (e.g. mercury) to penetrate the phosphor, thereby reducing the lifespan of the fluorescent lamp.

To prevent mercury penetration into light emitting layer 102, various embodiments include a protective layer 204 that includes fused silica (“quartz glass”) or a similar material that is substantially transmissive to both ultraviolet light in channel 108 and to visible light emanating from light-producing layer 202. “Substantially” in this context means that light is predominantly transmitted through the protective material, although some amount may be reflected and/or absorbed due to quantum effects, impurities in the coating material, imperfections in manufacturing, design or assembly of the lamp assembly, and/or other factors as appropriate.

Moreover, protective layer 204 should be at least partially formed of a material that is capable of filling small gaps in light emitting layer 202 while still allowing substantial transmission of UV and visible light. In various exemplary embodiments, the material selected has a molecular size that is small enough to fill gaps and cracks in light-emitting layer 202, yet large enough to prevent penetration by the vaporous materials in channel 108. Fused silica, for example, may be sputtered, deposited or otherwise applied in a protective layer 204 on light emitting layer 202 using any conventional technique.

In various embodiments, then, a fluorescent lamp assembly 104/106 may be made by simply forming a substrate 104 with one or more channels 108 of appropriate size and shape, applying the light emitting layer 202 within channel(s) 108, and then applying a suitable layer 204 of protective material on at least a portion of the light emitting material 202. Substrate 104 may be formed by molding, milling, sandblasting or other shaping techniques. Light emitting layer 202 may be applied by spraying or otherwise applying a layer of phosphor or other material. Finally, protective layer 204 may be applied by sputtering, deposition and/or any other suitable technique. In addition to providing the various benefits described above, various protective materials 204 such as fused silica may exhibit a further advantage in some embodiments in that such materials can be relatively easy to apply using conventional sputtering or deposition techniques that are effective, cost effective and efficient to use, even in relatively large-scale production environments.

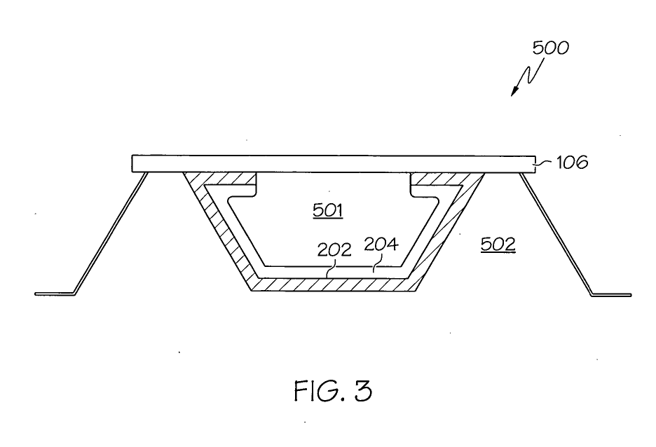

While the above examples have been described primarily with respect to a flat fluorescent lamp, these concepts may be equivalently applied in an aperture lamp or the like. The exemplary aperture lamp 500 shown in FIG. 3, for example, suitably includes a light emitting layer 202 that produces visible light in response to UV radiation generated by vaporous materials within channel 501. The light-emitting layer 202 in FIG. 3 is shown with a surface that is covered by a protective coating 204 of fused silica or the like. Although FIG. 3 shows protective layer 204 as predominantly protecting light emitting material 202, fused silica or other protective materials may be additionally applied to the underside of cover 106 to protect UV reflective coatings or the like that may be present on the aperture. The basic concept of applying a suitable protective layer may therefore be implemented and exploited in myriad ways across a wide cross section of alternate but equivalent embodiments.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims and their legal equivalents.

What is claimed is:

1. A fluorescent light source for providing a visible light, the light source comprising:
a channel configured confine a vaporous material that produces an ultra-violet light when electrically excited;
a layer of light-emitting material disposed within at least a portion of the channel that is responsive to the ultra-violet light to produce the visible light; and
a protective coating provided on the layer of light-emitting material, the protective coating comprising a protective material being substantially transmissive to the ultra-violet light and to the visible light.

2. The light source of claim 1 wherein the vaporous material comprises mercury, the light-emitting material comprises a phosphorescent material, and the protective material comprises fused silica.

3. The light source of claim 1 wherein the protective material comprises fused silica.

4. The light source of claim 1 wherein the vaporous material comprises mercury and the protective material comprises fused silica.

5. The light source of claim 1 further comprising a substantially transparent cover displaced on the channel to confine the vaporous material.

6. The light source of claim 1 wherein the protective material has a molecular size that is larger than the molecular size of the vaporous material but smaller than the molecular size of the light-emitting material.

7. The light source of claim 1 wherein the light source is a flat lamp.

8. The light source of claim 1 wherein the light source is an aperture lamp.

9. A flat panel display comprising the light source of claim 1.

10. A flat panel display comprising the light source of claim 2.

11. A fluorescent light source for providing a visible light, the light source comprising:
a channel configured confine a vaporous material comprising mercury that produces an ultra-violet light when electrically excited;
a layer of light-emitting phosphor material disposed within at least a portion of the channel that is responsive to the ultra-violet light to produce the visible light; and
a protective coating of fused silica substantially covering the layer of light-emitting phosphor.

12. A flat panel display comprising the light source of claim 11.

13. A method of making a fluorescent light source on a substrate having a channel formed therein, the method comprising the steps of:
forming a layer of phosphor material disposed within at least a portion of the channel; and
forming a protective layer of fused silica substantially covering the layer of phosphor material.

14. The method of 13 wherein the step of forming a protective layer comprises sputtering the protective layer of fused silica on the layer of phosphor material.

15. The method of claim 13 wherein the step of forming a protective layer comprises depositing the protective layer of fused silica on the layer of phosphor material.

16. The method of claim 13 further comprising the step of deforming the surface of the channel prior to either of the forming steps to thereby increase the surface area of the phosphor material disposed within the channel.

17. A fluorescent light source formed by the method of claim 13.
